(19) United States
(12) Patent Application Publication
(10) Pub. No.: US 2005/0098973 A1
(43) Pub. Date: May 12, 2005

(54) Wheel with offset hub

(76) Inventor: J. Todd Pace, Salt Lake City, UT (US)

Correspondence Address: STOEL RIVES LLP;One Utah Center, Suite 1100, 201 South Main Street, Salt Lake City, UT, 84111, US

(21) Appl. No.: 10/915,522

(22) Filed: Aug. 10, 2004

Related U.S. Application Data
(60) Provisional application No. 60/518,063, filed on Nov. 7, 2003.

(51) Int. Cl. B62M 1/00

(52) U.S. Cl. 280/87.041

(57) ABSTRACT

Disclosed are wheels having offset or adjustable offset hubs and wheeled vehicles incorporating such wheels. In one embodiment of the wheel, the hub is adjustable within a hub track so as to allow the hub to be positioned in a plurality of locations relative to the rim of the wheel. A vehicle incorporating a wheel with a hub positioned offset from the center of the wheel can be propelled or slowed using the rider's timed shifting momentum over the offset wheel, without requiring pedals.

### RELATED APPLICATIONS

This application claims the benefit under 35 U.S.C. § 119(e) of U.S. Provisional Patent Application No. 60/518,063, filed Nov. 7, 2003, titled “Wheel with Offset Hub,” which is incorporated herein by reference.

### TECHNICAL FIELD

The present invention relates generally to the fields of transportation and recreational vehicles. More specifically, the present invention relates to wheels including offset and/or adjustably offset hubs and vehicles incorporating such wheels.

### BRIEF DESCRIPTION OF THE DRAWINGS

FIG. 1 is a perspective view of a scooter incorporating two wheels with adjustable hubs.

FIG. 2 is an enlarged perspective view of the front wheel of the scooter.

FIG. 3 is a plan view of the front wheel shown in FIG. 2.

FIG. 4 is a side elevation view of the front wheel shown in FIGS. 2-3.

FIG. 5 is a cross-sectional view taken along line 5-5 in FIG. 4.

FIG. 6 is an exploded view of the front wheel shown in FIGS. 2-5.

FIG. 7 is an enlarged perspective view of the rear wheel of the scooter.

FIG. 8 is a plan view of the rear wheel shown in FIG. 7.

FIG. 9 is a side elevation view of the rear wheel shown in FIGS. 7-8.

FIG. 10 is a cross-sectional view taken along line 10-10 in FIG. 9.

FIG. 11 is an exploded view of the rear wheel shown in FIGS. 7-10.

### DETAILED DESCRIPTION OF PREFERRED EMBODIMENTS

In one embodiment, the wheel of the present invention is a wheel with a hub adapted to be offset from the center of the wheel. The hub may be permanently located offset from the center of the wheel or the hub may be adjustable from a centered position to one or more offset positions. When the adjustable hub is in the center position, the vehicle will move smoothly across a surface. When the performance provided by a hub in an offset position is desired, the hub can then be adjusted to an offset position. Embodiments of the wheel may be used for wheeled vehicles such as bicycles, tricycles, unicycles, scooters, in-line skates (also referred to as roller blades), go-carts, and skateboards. The wheel may be used for any number of the wheels on four-wheeled vehicles, such as go-carts and skateboards. For example, when used on four-wheeled vehicles, depending on the desired performance of the vehicle, all four wheels may have offset hubs, only the two front or two back may have offset hubs, or any other number of wheels may have offset hubs as desired. Similarly, for two-wheeled vehicles, such as bicycles or scooters, either or both of the wheels could have offset hubs.

As the wheel turns around the offset hub, the offset position of the hub causes the portion of the vehicle over the wheel to rise and fall. A vehicle with this type of wheel when ridden can be propelled forward or backward using the rider's momentum, without requiring pedals. The rider can control acceleration and deceleration by shifting his or her weight from front to back. The vehicle may be used for balance training, cardiovascular exercise, strength training, recreation, and/or as a novelty item.

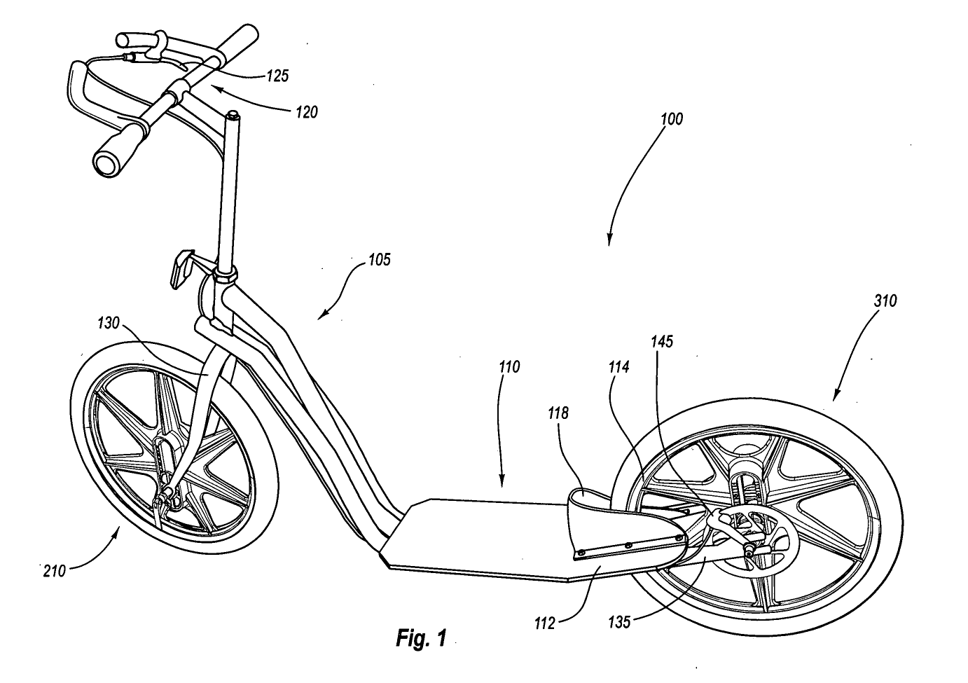

One embodiment of a scooter incorporating two wheels with adjustable hubs is shown in FIG. 1. Scooter 100 has a frame 105, running board 110, handle bars 120, front fork 130, front adjustable wheel 210, rear fork 135, and rear adjustable wheel 310. Front and rear adjustable wheels 210 and 310 each have hubs disposed within hub tracks. The hub tracks are disposed within the respective wheel frames. As will be discussed in greater detail later, a plurality of hub track teeth are connected with the respective hub tracks and each hub includes a plurality of hub teeth. The hub teeth and the hub track teeth are configured to mate with one another to allow the hub to be locked into position in a plurality of locations relative to the rim of each wheel. The scooter embodiment shown in FIG. 1 also includes a brake disk connected with the rear wheel hub such that the brake disk moves with the rear wheel hub. The brake disk is connected with a braking mechanism 145, which is connected with and operable by a brake lever 125 connected with one of the handle bars.

Embodiments of the invention may be configured to include one or more foot supports positioned adjacent to one or more rear wheels. For instance, on a two-wheeled vehicle, such as a bicycle or scooter, foot supports may be positioned on opposite sides of the rear wheel. On a three-wheeled vehicle, such as a tricycle, a single foot support capable of supporting two feet may be positioned in between the two rear wheels or, alternatively, two foot supports may be positioned adjacent to each of the rear wheels in between the rear wheels.

These foot supports may comprise pegs, pedals, platforms, etc. and may be integrally formed with or attached to a running board, to the wheel axle, or otherwise connected with the vehicle. As shown in FIG. 1, running board 110 may be split around the rear wheel so as to comprise first and second foot platforms-i.e., left foot platform 112 and right foot platform 114. In this embodiment, the foot supports comprise the foot platforms. Left and right foot platforms 112 and 114 are at least partially positioned on opposite sides of rear wheel 310. Preferably, both the first and second foot supports will be sufficiently large to allow a rider's feet to be positioned thereon with at least part of the rear wheel in between the rider's feet. In certain preferred embodiments, the two foot platforms are each at least about two inches wide. Foot supports allow a rider to position his or her weight over a wheel with an adjustable hub so that propelling the vehicle with the rider's weight is further facilitated.

A fender, such as fender 118 shown in FIG. 1, may optionally be disposed around at least a portion of the rear wheel. In FIG. 1, fender 118 is disposed between two foot platforms over the rear wheel. Of course, when used, the fender should leave sufficient space between the tire and the interior perimeter of the fender such that any of the various eccentricities of the rear wheel may be accommodated. A fender may be used to prevent interference between a rider's feet and the rear wheel(s). Fenders may also be used to provide alternate foot supports.

The hubs of the scooter shown in FIG. 1 may be positioned in any number of positions relative to the rims of the wheels. For instance, both hubs may be positioned at the center of their respective wheels in order to provide a smooth ride. The hubs may also be moved to a position offset from the center of the wheel. If the scooter begins with both wheels having their respective hubs in the same orientation (for example, both simultaneously high or low relative to the rims), the front and back of the bicycle will move up and down together, causing the bicycle to appear as though it is bouncing across the ground. Alternatively, if the bicycle begins with the wheels in opposite orientations (for example, one wheel with its hub high on the wheel and another with its hub low) the front and back portions of the bicycle will move up and down alternately. This alternating movement causes the bicycle to appear to be rocking as it moves across a surface. If the bicycle wheels start with the hubs at approximately one quarter-turn positions different from each other, the bicycle will appear to gallop as it moves across a surface. The unusual movement caused by the wheel with an offset hub may make the bicycle desirable as a novelty item for entertainment. This unusual wheel movement may also be useful for providing different exercise effects for both arms and legs depending on the wheel settings and relationships to one another.

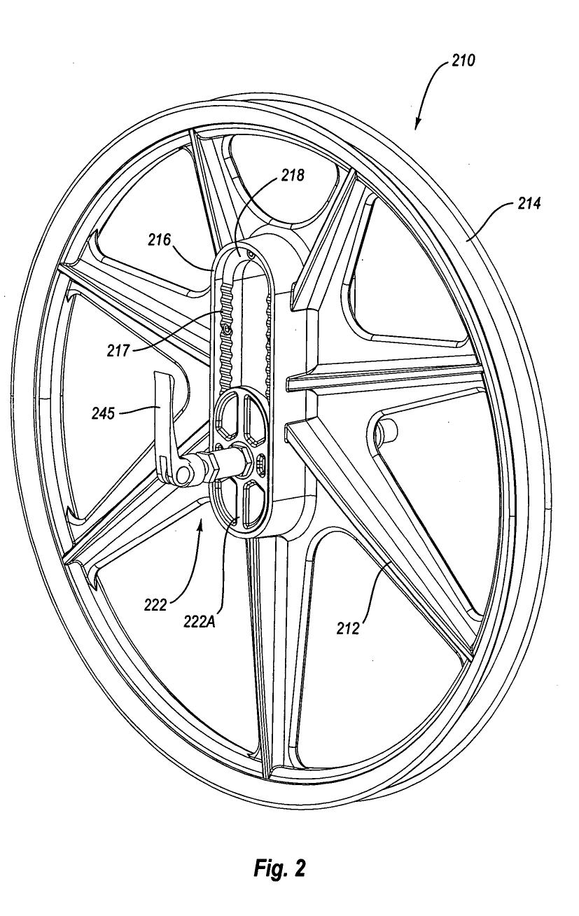

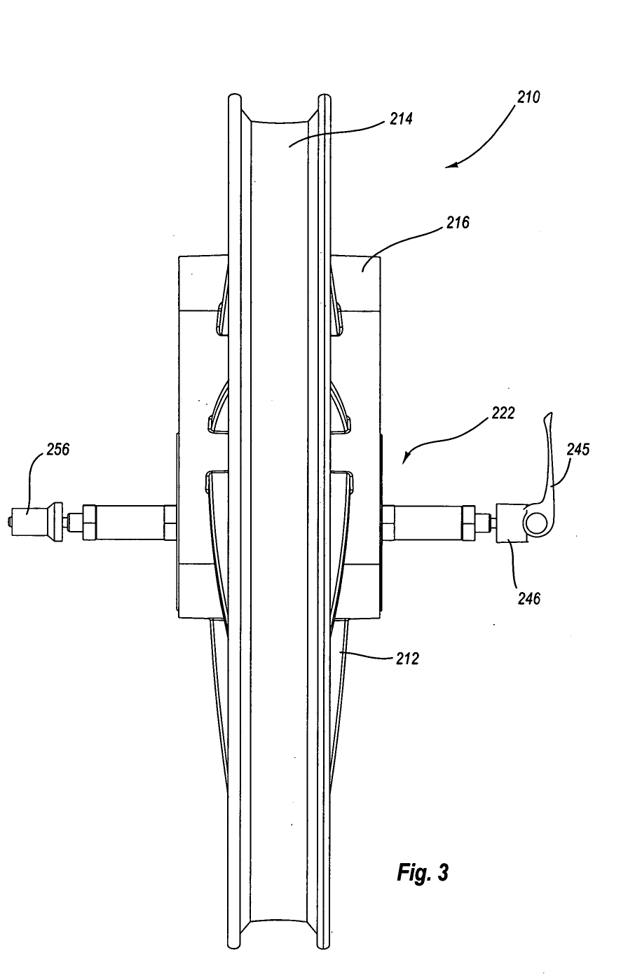

With reference now to FIGS. 2-6, the components of the adjustable front wheel will now be described in greater detail. Wheel 210 comprises a wheel frame 212 with a rim 214 extending around the perimeter of wheel frame 212. Rim 214 may be integral with, or attached or otherwise connected to, wheel frame 212. Hub track 216 is disposed within wheel frame 212 and extends through the center of wheel frame 212. Hub track 216 may be integral with wheel frame 212 or, alternatively, it may be attached or otherwise connected to the wheel frame. Hub track 216 includes a plurality of hub track teeth 217. Hub track teeth 217 may be disposed on one or more hub track plates 218. The Hub track plates may be attached to, or integrally formed with, hub track 216. The embodiment depicted in the accompanying figures has hub track plates 218 that are attached to hub track 216 with screws or bolts. As also shown in the accompanying figures, hub track plates 218 are situated opposite to one another and each hub track plate 218 has hub track teeth 217 that protrude in opposite directions away from the center of the wheel.

An adjustable hub 222 is disposed within hub track 216. The embodiment of hub 222 in FIGS. 2-6 includes first hub locking plate 222A and second hub locking plate 222B. First and second hub locking plates 222A and 222B may be connected to one another through openings in the respective hub locking plates. One or both hub locking plates may also include a plurality of hub teeth 227. The hub teeth 227 and the hub track teeth 217 may be configured to mate with one another to allow the hub 222 to be positioned in a plurality of locations relative to the rim 214.

The components used to connect and lock the hub locking plates 222A and 222B together in the hub track 216 will now be described. As can be seen from the figures, hub locking plate 222A has a bored projecting piece 223A and hub locking plate 222B has a bored projecting piece 223B. Several pieces, all of which comprise and will be referred to generally as an axle assembly, may then be fit together and extend through the two bore projecting pieces 223A and 223B to connect the hub locking plate 222A with hub locking plate 222B.

Nuts 231 may be arranged on opposite sides of spacers 232 on both ends of the axle assembly. Bearings 233 may then be arranged just inside of the inner nut 231 on either end of the axle assembly. Axle female piece 236 and axle male piece 238 are then arranged just inside of the bearings 233 on either end of the assembly. It should be understood that axle female piece 236 may be fixedly (understanding that “fixedly” does not imply that the piece cannot rotate relative to the plate) attached to hub locking plate 222A and axle male piece 238 may be fixedly attached to hub locking plate 222B (or vice versa) such that female portion 237 of axle female piece 236 extends at least partially through bored projecting piece 223A and male portion 239 of axle male piece 238 extends at least partially through bored projecting piece 223B. Pieces 236 and 238 may be fixedly attached to hub locking plates 222A and 222B by use of the axle assembly components described above or, alternatively, by any other methodology available to one of skill in the art.

Male portion 239 of axle male piece 238 has a smaller diameter than female portion 237 of axle female piece 236. As such, male portion 239 may be inserted into female portion 237. A spring, such as spring 242, may also be disposed between the two hub locking plates. In the depicted embodiment, spring 242 is disposed around the outer perimeter of male portion 239 and fits within the interior perimeter of female portion 237. Positioning spring 242 in between the two hub locking plates applies tension to the two hub locking plates such that they have the tendency to want to separate from one another with a repelling force. Spring 242 thereby facilitates readjustment of the hub in the hub track. Alternatively, spring 242 may be connected to the opposing hub locking plates so as to provide an attractive force between the plates. In such embodiments, hub locking plates may be pulled apart and readjusted to the desired location in the hub track, after which the plates will snap back together due to the force of the spring.

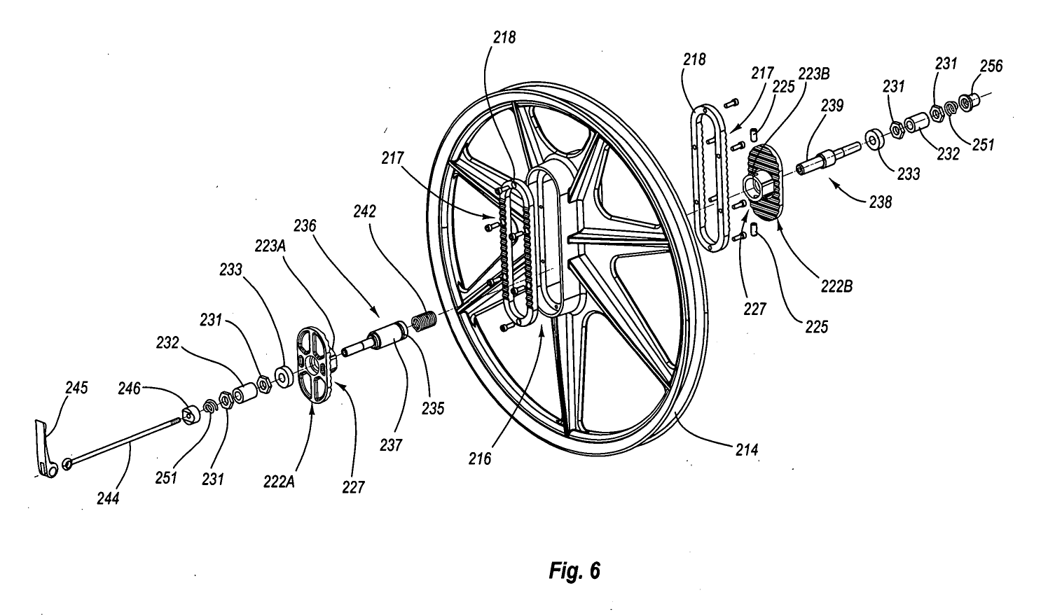

Embodiments of the invention may also include one or more detents, such as detents 225 shown in FIG. 6. Detents 225 are positioned in bored projecting piece 223B and are configured to fit within groove 235 on axle female piece 236. A sufficient repelling force on hub locking plates 222A and 222B, however, can unseat detent(s) 225 from groove 235 and thereby allow the hub locking plates to be separated from one another.

Axle rod 244 fits through bores in all of the axle assembly components on one side, through both hub locking plates 222A and 222B, and through all of the axle assembly components on the other side. A quick release lever 245 may be connected with the axle rod 244 at one end to allow for the hub locking plates to be quickly released from one another and readjusted to a different position within the hub track. Quick release lever ring 246 may also be included in a position adjacent to quick release lever 245. Quick release lever ring 246 may be formed with a groove substantially matching the contour of the rounded portion of quick release lever 245. In addition, a spring, such as pyramid spring 251, may be included in between the axle assembly and the quick release lever or quick release lever ring.

Once the hub locking plates have been positioned at the desired level within the hub track on opposite sides of the wheel, the hub connecting rod is inserted through the bores extending through each of the various components, as described above. The hubs may then be locked into place by attaching a threaded cap piece 256 onto the threaded end of the axle rod 244 and turning the quick release lever 245 to its closed position. A second spring, such as pyramid spring 251, may be included adjacent to the threaded cap piece 256. In embodiments not including a quick release mechanism, hub 222 may be locked in place at any point along hub track 216 with lug nuts, an additional cap piece, or other such mechanisms.

When one or more wheels as described herein are mounted on a wheeled vehicle, the rider may select and adjust the distance the hub and axle are offset from the center of the wheel from the center point of the wheel to a point up to the end of the hub track. Thus, the rider may select the center position, causing the wheel to turn evenly around the hub, providing a smooth ride, or an offset position, causing the wheel to turn unevenly around the hub, providing an uneven or bouncy ride. The rider may also select the amount of offset and thus the amount the wheel will cause the wheeled vehicle to bounce or buck as the wheel turns.

Wheels constructed in accordance with the foregoing principles may have frames molded with a solid material, such as plastic, carbon, or ceramic, such as the mag wheels shown in the accompanying figures. Alternatively, such wheels may have conventional spokes or solid frames.

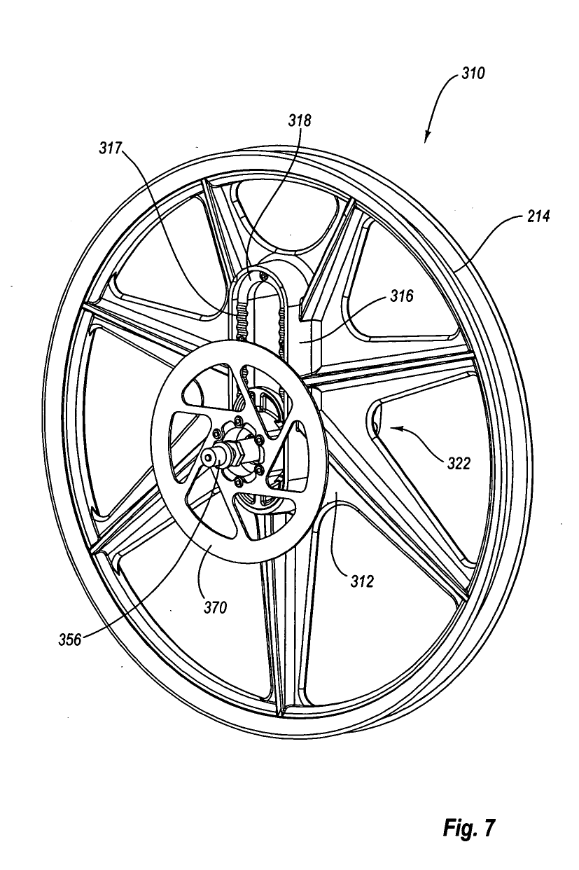

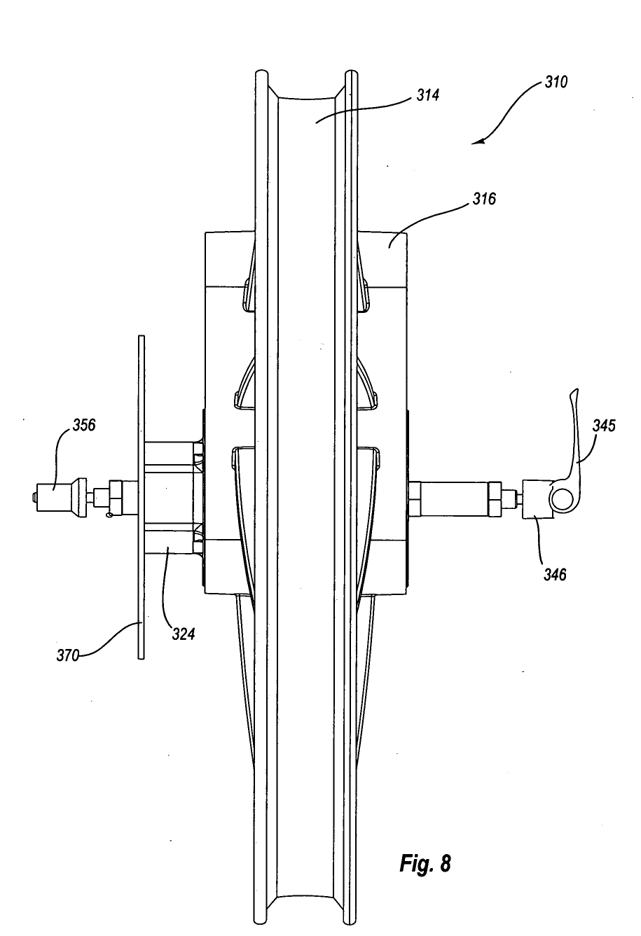

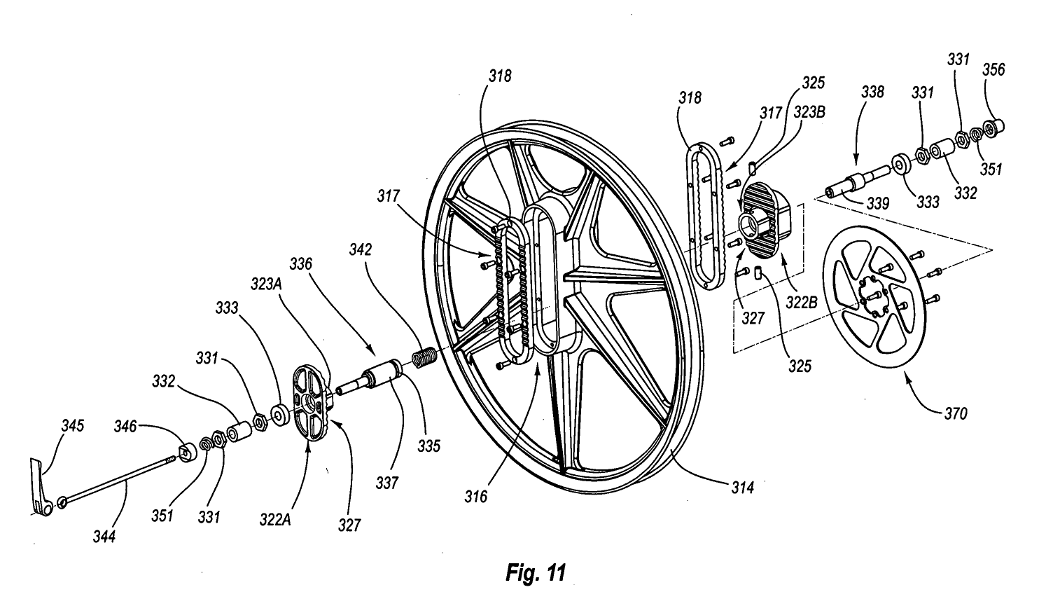

With reference now to FIGS. 7-11, the rear wheel 310 of scooter 100 will now be described in greater detail. Rear wheel 310 is similar to front wheel 210, but includes a brake disk 370. In order to attach the brake disk 370 to hub 322, one of hub locking plates 322A and 322B includes a brake disk mounting projection 324. Brake disk may then be mounted directly to the hub on brake disk mounting projection 324 by using screws, bolts, or the like, as best seen in FIG. 11. The other components of rear wheel 310 may essentially be the same as front wheel 210, and include (with reference to FIG. 11 from left to right) quick release lever 310, axle rod 344, quick release lever ring 346, pyramid spring 351, nut 331, spacer 332, nut 331, bearing 333, first hub locking plate 322A, axle female piece 336, spring 342, two opposing hub track plates 317 second hub locking plate 322B with brake disk mounting projection 324, brake disk 370, axle male piece 338, bearing 333, nut 331, spacer 332, nut 331, pyramid spring 351, and threaded cap piece 356. As described above, brake disk 370 is adapted to be used with a braking mechanism, such as braking mechanism 145 shown in FIG. 1. Braking mechanism 145 and other such braking mechanisms operate in accordance with principles well known to those of skill in the art. Braking mechanism 145 is connected with a braking lever 125 typically located on the handle bars 120 or another convenient location for the rider.

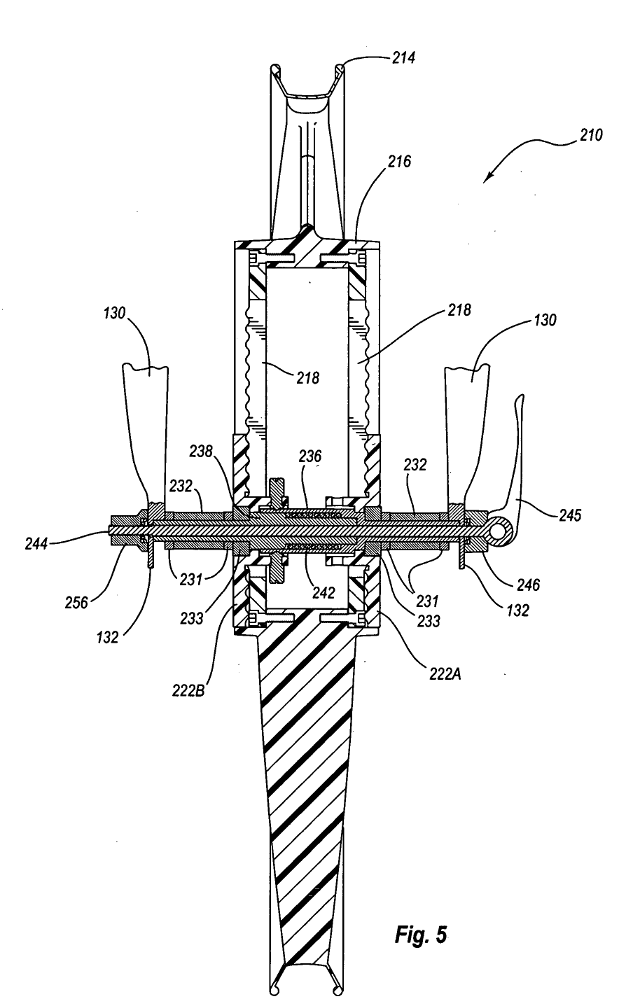

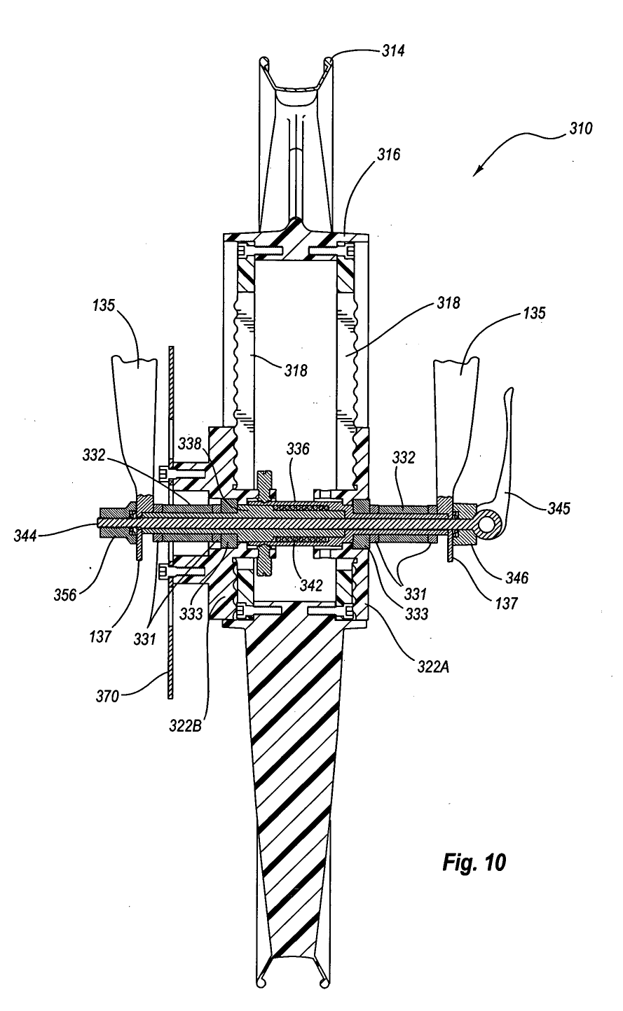

As shown in FIG. 1, and as best seen in FIGS. 5 and 10, front fork 130 fits over the front wheel axle assembly and rear fork 135 fits over the rear wheel axle assembly. Most typically, front fork projections 132 may be positioned around the axle in between the quick release lever ring 246 and a nut 231 on one side of the front wheel and in between the threaded cap piece 256 and a nut 231 on the other side. Likewise, rear fork projections 137 may be positioned around the rear axle in between quick release lever ring 346 and nut 331 on one side of the rear wheel and in between threaded cap piece 356 and nut 331 on the other side.

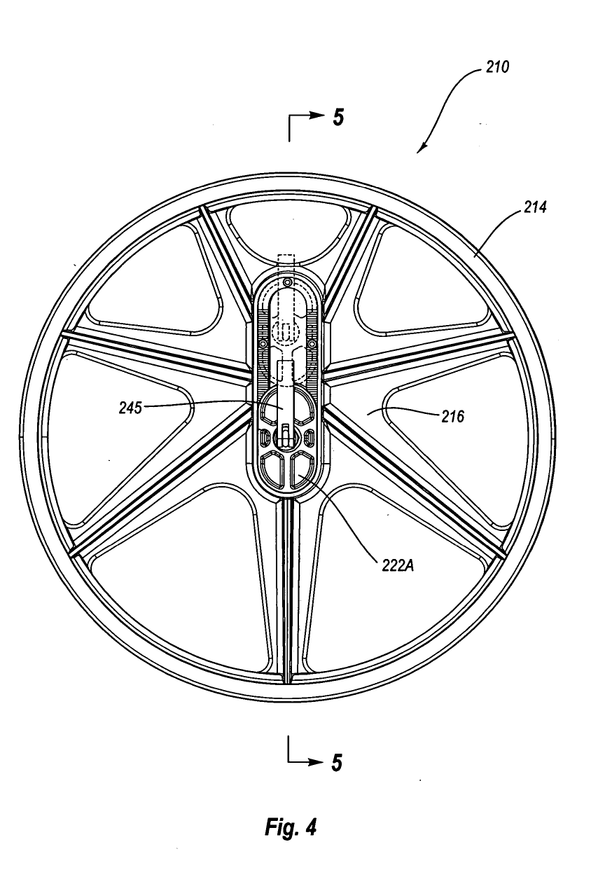

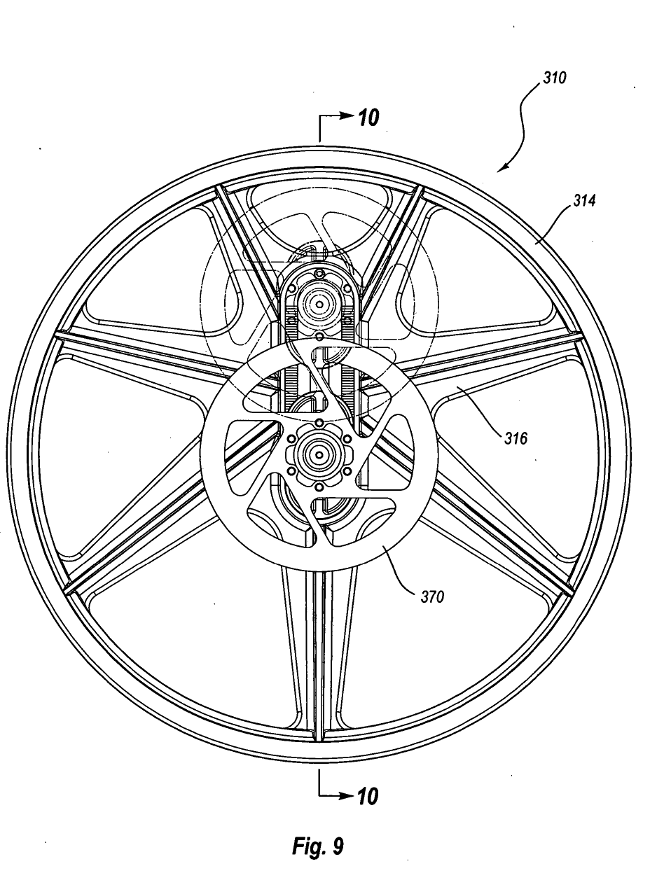

As shown in FIG. 4 and FIG. 9, the hubs on the front and rear wheels may be positioned at the bottom of the hub track, the top of the hub track (depicted in phantom), or any of a plurality of locations therebetween. Of course, the number of locations at which the respective hubs may be positioned in the respective hub tracks depends on the number of teeth on the hub locking plates and hub track plates. The number of teeth used in a given embodiment of a wheel with an adjustable hub may vary significantly as desired.

In embodiments of the invention including a fixed hub, the hub may be mounted at any desired distance from the center point of the wheel. In some preferred embodiments, the hub will be mounted away from the center point at a distance ranging about ⅓ r to about ⅔ r (wherein r represents the radius of the wheel). A front wheel of one embodiment has a radius of about 8¼ inches and the hub is mounted at a distance of about 2¼ inches from the center point. The rear wheel of this embodiment also with a radius of about 8¼ inches, with the hub being mounted at a distance of about 3 inches from its center point. In another embodiment, the hub is positioned at about 30% of the wheel's diameter away from the rim of the wheel.

The rear wheel may have a greater offset because in many embodiments of wheeled vehicles, a rider's weight is typically distributed so that the greatest proportion of the rider's weight is over the rear wheel. Providing a greater offset on the rear wheel allows the rider to more effectively use his or her weight and momentum to move the vehicle.

It will be obvious to those having skill in the art that many changes may be made to the details of the above-described embodiments without departing from the underlying principles of the invention. The scope of the present invention should, therefore, be determined only by the following claims.

1. A wheel for use on a wheeled vehicle comprising:
a wheel frame;
a rim extending around the perimeter of the wheel frame;
a hub track disposed within the wheel frame, a plurality of hub track teeth connected with the hub track; and
a hub disposed within the hub track, wherein the hub includes a plurality of hub teeth, and wherein the hub teeth and the hub track teeth are configured to mate with one another to allow the hub to be positioned in a plurality of locations relative to the rim.

2. The wheel of claim 1, wherein the hub track comprises a hub track plate, and wherein the hub track teeth are disposed on the hub track plate.

3. The wheel of claim 2, further comprising:
a second plurality of hub track teeth connected with the hub track; and
a second plurality of hub teeth connected with the hub, wherein the second plurality of hub track teeth are configured to mate with the second plurality of hub teeth.

4. The wheel of claim 1, wherein the hub comprises first and second hub locking plates that are connectable to one another through openings in the respective hub locking plates, and wherein the first and second hub locking plates each comprise a plurality of hub teeth.

5. The wheel of claim 4, further comprising a spring disposed between the first and second hub locking plates.

6. The wheel of claim 1, wherein the hub track is integral with the wheel frame.

7. The wheel of claim 1, wherein the rim is integral with the wheel frame.

8. The wheel of claim 1, further comprising a quick release mechanism connected with the hub, wherein the quick release mechanism includes a quick release lever, and wherein the quick release lever is configured such that turning the lever in one direction increases the tension on a fork connected to the hub and turning the lever in the other direction decreases the tension on a fork connected to the hub.

9. A wheel for use on a wheeled vehicle comprising:
a wheel frame;
a rim extending around the perimeter of the wheel frame;
a hub track disposed within the wheel frame;
a hub disposed within the hub track and movable relative to the hub track, wherein the hub and hub track are configured to allow the hub to be positioned in a plurality of locations relative to the rim; and
a brake disk connected with the hub such that the brake disk moves with the hub as the hub is moved in the hub track.

10. The wheel of claim 9, wherein the hub comprises first and second hub locking plates that are connectable to one another through openings in the respective hub locking plates.

11. The wheel of claim 9, wherein the hub track is integral with the wheel frame.

12. A wheeled vehicle comprising:
a frame;
a first wheel connected with the frame, wherein the first wheel has a rim and a hub, and wherein the first wheel hub is adapted to be positioned in a plurality of locations relative to the first wheel rim; and
a second wheel connected with the frame, wherein the second wheel has a rim and a hub, and wherein the second wheel hub is adapted to be positioned in a plurality of locations relative to the second wheel rim.

13. The wheeled vehicle of claim 12, wherein the frame comprises a scooter frame, wherein the first and second wheels each comprise hub tracks, wherein the first and second wheel hub tracks each comprise hub track teeth connected with the respective hub tracks, wherein the first and second wheel hubs each comprise a plurality of hub teeth, and wherein the first wheel hub track teeth are configured to mate with the first wheel hub teeth and the second wheel hub track teeth are configured to mate with the second wheel hub teeth to allow the first and second wheel hubs to be positioned in a plurality of locations relative to the respective first and second wheel rims.

14. The scooter of claim 12, further comprising a brake disk connected with the second wheel hub such that the brake disk moves with the second wheel hub.

15. The scooter of claim 14, further comprising a second brake disk connected with the first wheel hub such that the second brake disk moves with the first wheel hub.

16. The scooter of claim 12, further comprising a third wheel connected with the scooter frame, wherein the third wheel has a rim and a hub, and wherein the third wheel hub is adapted to be positioned in a plurality of locations relative to the third wheel rim.

17. A wheeled vehicle comprising:
a frame;
a first wheel connected with the frame;
a second wheel connected with the frame, wherein the second wheel has a rim and a hub, and wherein the second wheel hub is adapted to be positioned in a plurality of locations relative to the second wheel rim; and
at least one foot support positioned adjacent to the second wheel.
at least first and second foot supports positioned on opposite sides of the second wheel.

18. The wheeled vehicle of claim 17, wherein the frame comprises a scooter frame, wherein the scooter frame comprises a running board connected with the scooter frame, wherein the running board comprises two foot supports comprising first and second foot platforms, wherein the running board is split around the second wheel so as to comprise the foot supports, and wherein both the first and second foot platforms are sufficiently large to allow a rider's feet to be positioned on the first and second platforms with at least part of the second wheel in between the rider's feet.

19. The wheeled vehicle of claim 17, further comprising a fender disposed around at least a portion of the second wheel.

20. The wheeled vehicle of claim 17, wherein the foot support is at least about two inches wide.

21. The wheeled vehicle of claim 17, wherein the foot support comprises one or more pegs extending from the axle of the second wheel.

22. The wheeled vehicle of claim 17, wherein the first wheel has a rim and a hub, and wherein the first wheel hub is adapted to be positioned in a plurality of locations relative to the first wheel rim.

23. The wheeled vehicle of claim 17, further comprising a third wheel connected with the frame.

24. The wheeled vehicle of claim 23, wherein the at least one foot support comprises a foot support capable of supporting two feet, and wherein the foot support is positioned in between the second and third wheels.

25. The wheeled vehicle of claim 23, wherein the at least one foot support comprises at least two foot supports positioned adjacent to the second and third wheels in between the second and third wheels.

26. The wheeled vehicle of claim 23, wherein the third wheel has a rim and a hub, and wherein the third wheel hub is adapted to be positioned in a plurality of locations relative to the third wheel rim.
